(19) United States
(12) Patent Application Publication
(10) Pub. No.: US 2021/0319592 A1
(43) Pub. Date: Oct. 14, 2021

(54) ELECTRONIC DEVICE AND METHOD FOR ENCODING AND DECODING POINT CLOUD

(71) Applicant: Industrial Technology Research Institute, Hsinchu (TW)

(72) Inventors: Yi-Ting Tsai, Hsinchu County (TW); Ching-Chieh Lin, Hsinchu City (TW); Chun-Lung Lin, Taipei City (TW)

(73) Assignee: Industrial Technology Research Institute, Hsinchu (TW)

(21) Appl. No.: 17/120,267

(22) Filed: Dec. 14, 2020

Related U.S. Application Data
(60) Provisional application No. 63/009,460, filed on Apr. 13, 2020.

(51) Int. Cl. G06T 9/00; G06T 17/20

(52) U.S. Cl. CPC G06T 9/001; G06T 17/205

(57) ABSTRACT

An electronic device and a method for encoding and decoding a point cloud are provided. The decoding method includes: encoded image data and syntax are received; the encoded image data is decoded to obtain image data, and a raw patch is obtained from the image data; and a residual point cloud in the point cloud is reconstructed according to the raw patch and the syntax.

### CROSS-REFERENCE TO RELATED APPLICATION

This application claims the priority benefit of U.S. Provisional Application No. 63/009,460, filed on Apr. 13, 2020. The entirety of the above-mentioned patent application is hereby incorporated by reference herein and made a part of this specification.

### TECHNICAL FIELD

The disclosure relates an electronic device and a method for encoding and decoding a point cloud.

### BACKGROUND

A point cloud is a set of data points in a specific space and may be configured to present a three-dimensional object. Each point in the point cloud may include information such as coordinate, color, reflectance, or transparency. In the current point cloud encoding technology, a point cloud corresponding to a three-dimensional object is projected onto one or more planes of a bounding box (BB) to generate a two-dimensional image including one or more patches. However, the point cloud restored by the two-dimensional image will be distorted. FIG. 1A is a schematic diagram showing projecting a three-dimensional point cloud 10 onto a bounding box 20 to generate two-dimensional image data 30 including a plurality of patches. When encoding the three-dimensional point cloud 10, the three-dimensional point cloud 10 may be projected onto six planes of the bounding box surrounding the three-dimensional point cloud 10 to respectively generate a patch 11, a patch 12, a patch 13, a patch 14, a patch 15, and a patch 16. In this way, the three-dimensional point cloud 10 may be encoded into the two-dimensional image data 30 including the patch 11, the patch 12, the patch 13, the patch 14, the patch 15, and the patch 16.

However, projections of a plurality of points of the three-dimensional point cloud 10 may be the same. FIG. 1B is a schematic diagram showing distortion generated during converting the three-dimensional point cloud 10 into the two-dimensional image data 30. It is assumed that a plane 21 and a plane 22 are two parallel planes of the bounding box 20. Projections of points 41, 42, 43, 44, and 45 in the three-dimensional point cloud 10 on the plane 21 are the same. Similarly, projections of the points 41, 42, 43, 44, and 45 on the plane 22 are the same. Therefore, among the points 41, 42, 43, 44, and 45, only the point 41 closest to the plane 21 may be projected onto the plane 21, and only the point 45 closest to the plane 22 may be projected onto the plane 22. Therefore, the patch in the two-dimensional image data 30 only includes information of the point 41 and the point 45, but not information of the points 42, 43, and 44. In other words, the restored point cloud generated with the two-dimensional image data 30 will lose the information of the points 42, 43, and 44, thereby resulting in distortion.

Based on the above, how to propose a technology that encodes and decodes a point cloud without distortion is one of the objectives of people in the field.

### SUMMARY

The disclosure provides an electronic device and a method for encoding and decoding a point cloud, which encodes and decodes a point cloud without distortion.

In the disclosure, an electronic device for encoding a point cloud includes a processor, a storage medium, and a transceiver. The transceiver obtains the point cloud, where the point cloud includes a plurality of points in a bounding box. The storage medium stores a plurality of modules. The processor is coupled to the storage medium and the transceiver, and accesses and executes the plurality of modules, where the plurality of modules include a computing module and an image encoding module. The computing module obtains a residual point cloud from the point cloud, defines a reference point in the bounding box, and generates a raw patch according to the reference point and the residual point cloud. The image encoding module generates image data according to the raw patch, and generates encoded image data according to the image data, where the computing module outputs the encoded image data through the transceiver.

In the disclosure, an electronic device for decoding a point cloud includes a processor, a storage medium, and a transceiver. The transceiver receives encoded image data and syntax. The storage medium stores a plurality of modules. The processor is coupled to the storage medium and the transceiver, and accesses and executes the plurality of modules, where the plurality of modules include an image decoding module and a computing module. The image decoding module decodes the encoded image data to obtain image data, and obtains a raw patch from the image data. The computing module reconstructs a residual point cloud in the point cloud according to the raw patch and the syntax.

In the disclosure, a method for encoding a point cloud includes: the point cloud is obtained, where the point cloud includes a plurality of points in a bounding box; a residual point cloud is obtained from the point cloud; a reference point in the bounding box is defined; a raw patch is generated according to the reference point and the residual point cloud; image data is generated according to the raw patch, and encoded image data is generated according to the image data; and the encoded image data is output.

In the disclosure, a method for decoding a point cloud includes: encoded image data and syntax are received; the encoded image data is decoded to obtain image data, and a raw patch is obtained from the image data; and a residual point cloud in the point cloud is reconstructed according to the raw patch and the syntax.

Based on the above, in the disclosure, the point cloud is encoded and decoded without distortion, and a compression ratio of the point cloud is increased.

### BRIEF DESCRIPTION OF THE DRAWINGS

FIG. 1A is a schematic diagram showing projecting a three-dimensional point cloud onto a bounding box to generate two-dimensional image data including a plurality of patches.

FIG. 1B is a schematic diagram showing distortion generated during converting the three-dimensional point cloud into the two-dimensional image data.

FIG. 2 is a schematic diagram showing an electronic device for encoding a point cloud according to an embodiment of the disclosure.

FIG. 3 is a flow chart showing a method for encoding a point cloud according to an embodiment of the disclosure.

FIG. 4A is a schematic diagram showing a bounding box and sub-bounding boxes according to an embodiment of the disclosure.

FIG. 4B is a schematic diagram showing a raw patch according to an embodiment of the disclosure.

FIG. 5 is a schematic diagram showing generating the value associated with the residual point cloud according to the embodiment of the disclosure.

FIG. 6A, FIG. 6B, and FIG. 6C are schematic diagrams showing a sub-bounding box and a raw patch according to an embodiment of the disclosure.

FIG. 7 is a schematic diagram showing an electronic device for decoding a point cloud according to the embodiment of the disclosure.

FIG. 8 is a flow chart showing a method for decoding a point cloud according to an embodiment of the disclosure.

FIG. 9 is a schematic diagram showing calculating the number of residual points in the current residual point cloud according the embodiment of the disclosure.

FIG. 10 is a flow chart showing a method for encoding a point cloud according to another embodiment of the disclosure.

FIG. 11 is a flow chart showing a method for decoding a point cloud according to another embodiment of the disclosure.

### DESCRIPTION OF THE EMBODIMENTS

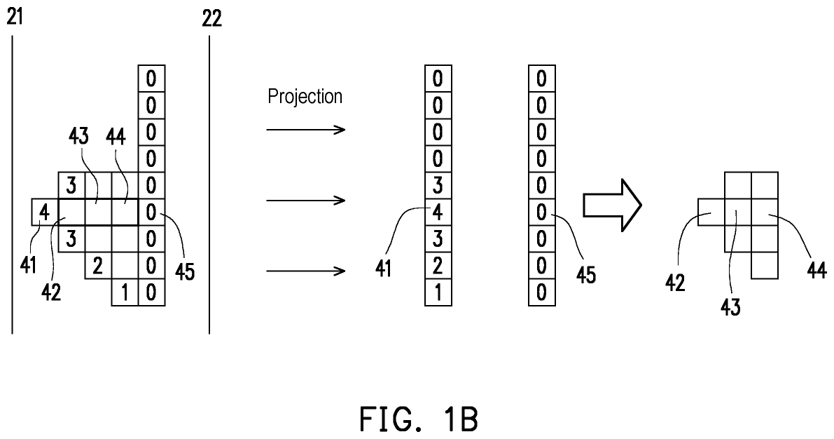

FIG. 2 is a schematic diagram showing an electronic device 100 for encoding a point cloud according to an embodiment of the disclosure. The electronic device 100 may include a processor 110, a storage medium 120, and a transceiver 130.

The processor 110 is, for example, a central processing unit (CPU), or any other programmable general-purpose or special-purpose micro control unit (MCU), microprocessor, digital signal processor (DSP), programmable controller, application-specific integrated circuit (ASIC), graphic processing unit (GPU), image signal processor (ISP), image processing unit (IPU), arithmetic logic unit (ALU), complex programmable logic device (CPLD), field programmable gate array (FPGA), or other similar elements or a combination of the above elements. The processor 110 may be coupled to the storage medium 120 and the transceiver 130, and access and execute a plurality of modules and various applications stored in the storage medium 120.

The storage medium 120, for example, is a fixed or portable element in any form such as random access memory (RAM), read only memory (ROM), flash memory, hard disk drive (HDD), solid state drive (SSD), or a combination of the above elements, and is configured to store a plurality of modules or various application programs that may be executed by the processor 110. In this embodiment, the storage medium 120 may store a plurality of modules including a computing module 121, an image encoding module 122, and a predicting model 123, and functions thereof will be described later.

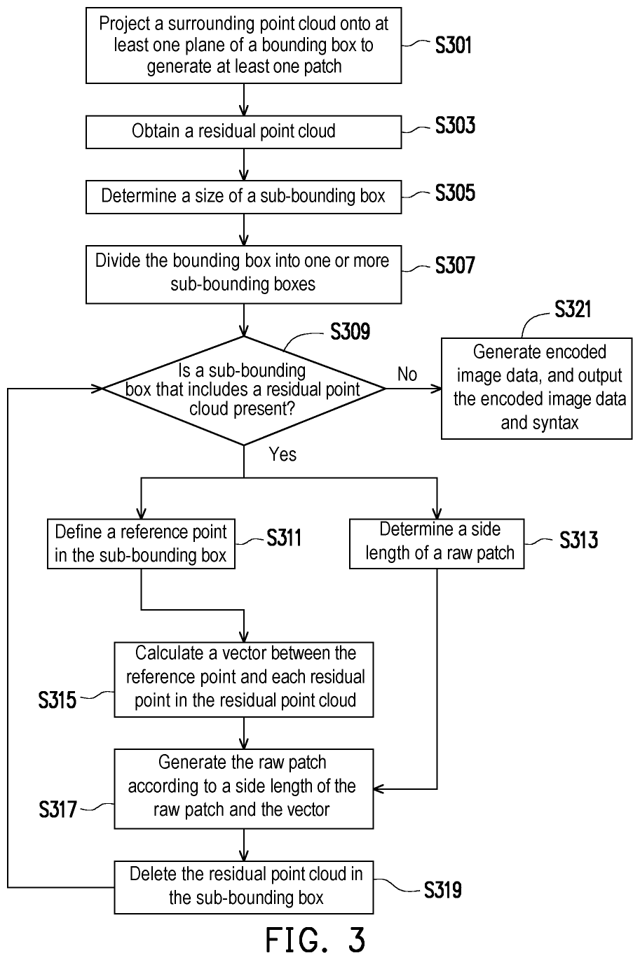

The transceiver 130 transmits and receives signals in a wireless or wired manner. The transceiver 130 may also perform operations such as low noise amplification, impedance matching, frequency mixing, frequency up-conversion or down-conversion, filtering, amplification, and the like. The transceiver 130 may receive a point cloud video. The computing module 121 may obtain the point cloud from the point cloud video. The point cloud may include a plurality of points in a bounding box. Taking FIG. 4A as an example, the point cloud may include points 411, 412, 431, 432, and 433 in a bounding box 400. The point cloud in the point cloud video may vary depending on time. For example, a current point cloud corresponding to a current frame of the point cloud video may be completely or partially different from (or same as) a previous point cloud corresponding to a previous frame of the point cloud video.

In an embodiment, the point cloud obtained by the computing module 121 may be the current point cloud corresponding to the current frame of the point cloud video. Herein, the current point cloud may include a current surrounding point cloud and a current residual point cloud.

In an embodiment, the point cloud obtained by the computing module 121 may be a point cloud generated from subtracting the previous point cloud corresponding to the previous frame of the point cloud video from the current point cloud corresponding to the current frame of the point cloud video. Herein, the current point cloud may include the current surrounding point cloud and the current residual point cloud, and the previous point cloud may include a previous surrounding point cloud and a previous residual point cloud. If the point cloud is positive, it means that the point cloud is an increased point cloud of the current frame compared with the previous frame. If the point cloud is negative, it means that the point cloud is a decreased point cloud of the current frame compared with the previous frame.

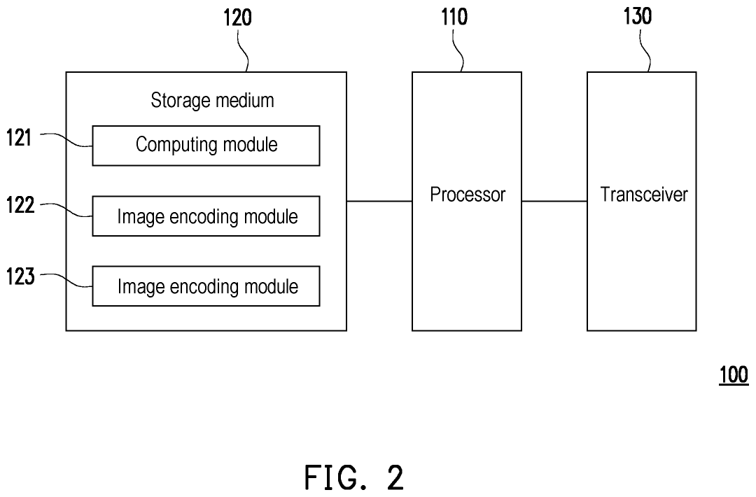

FIG. 3 is a flow chart showing a method for encoding a point cloud according to an embodiment of the disclosure. Herein, the method may be implemented by the electronic device 100 as shown in FIG. 2.

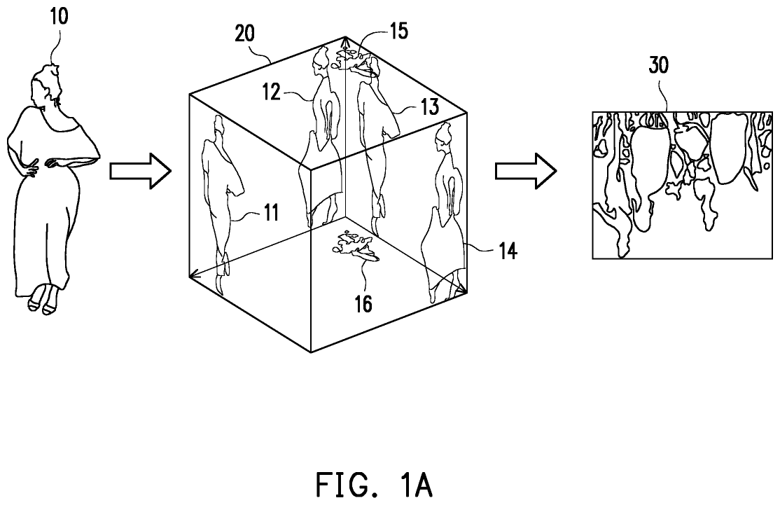

In step S301, the computing module 121 may project a surrounding point cloud in the point cloud onto at least one plane of the bounding box to generate at least one patch. The surrounding point cloud is a subset of the point cloud and is formed of at least one surrounding point. Herein, the surrounding point is a point in the point cloud that may be projected onto any plane of the bounding box, and a projection of the surrounding point on the plane of the bounding box may be retained by the computing module 122 for generating a patch. The computing module 122 may place the patch into image data, and remove the surrounding point cloud for generating the patch from the point cloud. The rules for determining a surrounding point may be customized by a user. In an embodiment, it is possible that no other points are present on the shortest path between the surrounding point and the plane of the bounding box, and the projection of the surrounding point on the plane (or an opposite plane of the plane) may be retained to generate the patch. Taking FIG. 1A as an example, the computing module 121 may project a surrounding point of the point cloud 10 onto each plane of the bounding box 20 to generate the patches 11, 12, 13, 14, 15, and 16, and may place the patches 11, 12, 13, 14, 15, and 16 into the two-dimensional image data 30. Then, the computing module 121 may remove the surrounding point for generating the patches 11, 12, 13, 14, 15, and 16 from the point cloud 10.

In an embodiment, when the plurality of points in the point cloud are projected onto the same position on a specific plane of the bounding box, only a specific number of points in the plurality of points may serve as the surrounding point projected onto the specific plane. Herein, the specific number may be customized by the user. Taking FIG. 1B as an example, when it is assumed that the user defines the specific number as 1, then for the plane 21, among the points 41, 42, 43, 44, and 45 in the point cloud, only one single point (e.g., the point 41) may serve as the surrounding point corresponding to the plane 21. No other points are present on the shortest path between the point 41 and the plane 21. On the other hand, for the plane 22, among the points 41, 42, 43, 44, and 45 in the point cloud, only one single point (e.g., the point 45) may serve as the surrounding point corresponding to the plane 22. No other points are present on the shortest path between the point 45 and the plane 22. Therefore, among the points 41, 42, 43, 44, and 45, only the points 41 and 45 may serve as the surrounding points and be projected onto the plane of the bounding box to generate the patch.

For another example, when it is assumed that the user defines the specific number as 2, then for the plane 21, among the points 41, 42, 43, 44, and 45 in the point cloud, only two of the points 41, 42, 43, 44, and 45 (e.g., the point 41 and the point 45) may serve as the surrounding points corresponding to the plane 21. The projections of the two surrounding points on the plane 21 may be retained to thereby generate a specific number of patches corresponding to the plane 21.

In step S303, the computing module 121 may obtain a residual point cloud from the point cloud. The residual point cloud may be formed of a point other than the surrounding point in the point cloud. After the surrounding point cloud in the point cloud is removed by the computing module 121 in step S301, the remaining part of the point cloud is namely the residual point cloud. Specifically, the residual point cloud may be a subset of the point cloud, and may be formed of at least one residual point. Herein, the residual point is a point in the point cloud that is repeatedly projected onto any plane of the bounding box. Other points may be present on the shortest path between the residual point and any plane of the bounding box. Taking FIG. 1B as an example, the point 41 is present on the shortest path between the point 42 (or the points 43, 44) and the plane 21 of the bounding box, so the point 42 (or the points 43, 44) may serve as the residual point. The point 45 is present on the shortest path between the point 42 (or the points 43, 44) and the plane 22 of the bounding box, so the point 42 (or the points 43, 44) may serve as the residual point. In the conventional point cloud encoding technology, the residual point will be discarded during encoding. Therefore, the point cloud restored after decoding the encoded data of the point cloud will lose information related to the residual point. Relatively speaking, the encoding method of the disclosure retains the information related to the residual point during encoding of the point cloud.

In step S305, the computing module 121 may determine a size of a sub-bounding box. The size of the sub-bounding box may be less than or equal to the bounding box, and a side length of the bounding box may be an integer multiple of a side length of the sub-bounding box. The size of the sub-bounding box may be customized by the user. For example, the computing module 121 may receive information including the size of the sub-bounding box through the transceiver 130. For another example, the information of the size of the sub-bounding box may be stored in the storage medium 120 in advance. FIG. 4A is a schematic diagram showing the bounding box 400 and sub-bounding boxes according to an embodiment of the disclosure. A size of a sub-bounding box 410 (or sub-bounding boxes 420, 430) may be less than or equal to the bounding box 400, and a side length of the bounding box 400 may be an integer multiple of a side length of the sub-bounding box 410 (or the sub-bounding boxes 420, 430), but the disclosure is not limited thereto.

In step S307, the computing module 121 may divide the bounding box into one or more sub-bounding boxes according to the size of the sub-bounding box. Taking FIG. 4A as an example, the computing module 121 may divide the bounding box 400 into the sub-bounding boxes 410, 420, and 430.

In step S309, the computing module 121 may determine whether a sub-bounding box that includes a residual point cloud is present. If a sub-bounding box that includes a residual point cloud is present, then the sub-bounding box is selected and step S311 and step S313 are entered. If no sub-bounding box that includes a residual point cloud is present, step S321 is entered.

In step S311, the computing module 121 may define a reference point in the sub-bounding box. In step S313, the image encoding module 122 may determine a patch size of a raw patch corresponding to the sub-bounding box. The reference point may be adopted to generate the raw patch corresponding to the sub-bounding box. The raw patch may be adopted to record information related to the residual point cloud in the sub-bounding box.

In an embodiment, the image encoding module 122 may determine the patch size of the raw patch according to an image encoding algorithm (including but not limited to an HEVC algorithm, an H.264 algorithm, an H.266 algorithm, an H.267 algorithm, an H.268 algorithm, or an H.269 algorithm) used by the image encoding module 122. In an embodiment, the raw patch may be formed of at least one block. After the image encoding module 122 determines a size of the at least one block, the number of data points of each block in the at least one block in a luma channel or a color channel may be determined. The image encoding module 122 may determine the number of the at least one block for forming the raw patch corresponding to the sub-bounding box according to the number of data points and the number of residual points in the sub-bounding box, to thereby determine the patch size of the raw patch according to the number of the at least one block.

FIG. 4B is a schematic diagram showing a raw patch 450 according to an embodiment of the disclosure. When it is assumed that the image encoding module 122 determines that a block for forming the raw patch 450 is, for example, a square with a side length of 6 (but the block is not limited to a square), then the block may include 6*6=36 data points in the luma channel, and the 36 data points may record information related to 12 residual points. For example, the block may record information (dX1, dY1, dZ1) related to a specific residual point in the residual point cloud with 3 data points. When the number of residual points in the sub-bounding box is more than 12, one single block will not be able to completely record the information of all the residual points. Therefore, the number of blocks requires to be increased (i.e., the patch size of the raw patch requires to be increased). The image encoding module 122 may calculate the number of blocks according to formula (1), where PS is the number of blocks required for forming the raw patch, RP is the number of residual points in the sub-bounding box, and LC is the number of data points of the block in the luma channel. Herein, PS, RP, and LC are positive integers.

$$P S = ⌈ \frac{R P}{L C} ⌉ \qquad ( 10$$

On the other hand, the computing module 121 may generate syntax corresponding to the sub-bounding box according to the reference point and the residual point cloud in the sub-bounding box. The syntax may include a coordinate of the reference point in the sub-bounding box, and may include a value associated with the residual point cloud in the sub-bounding box. When it is assumed that, in the current frame corresponding to the point cloud video, the current residual point cloud in the sub-bounding box includes N residual points (N may be a positive integer), and a reference residual point cloud corresponding to the sub-bounding box includes M residual points (M may be a natural number), then the value associated with the residual point cloud may be a difference between N and M. In an embodiment, a predetermined value of M may be 0 or 1.

In an embodiment, the reference residual point cloud may be agreed in advance by an encoding end (e.g., the electronic device 100) and a decoding end (e.g., an electronic device 200). In an embodiment, the reference residual point cloud may be generated according to the previous residual point cloud in the sub-bounding box. When it is assumed that, in the previous frame corresponding to the point cloud video, the previous residual point cloud in the sub-bounding box includes M residual points, then the M residual points may form the reference residual point cloud. Where the residual point cloud is known to the decoding end (e.g., the electronic device 200), only the information related to the residual point cloud generated from subtracting the M residual points of the reference residual point cloud from the N residual points of the current residual point cloud is required to be transmitted by the encoding end (e.g., the electronic device 100) to the decoding end for the decoding end to completely restore the residual point cloud in the sub-bounding box.

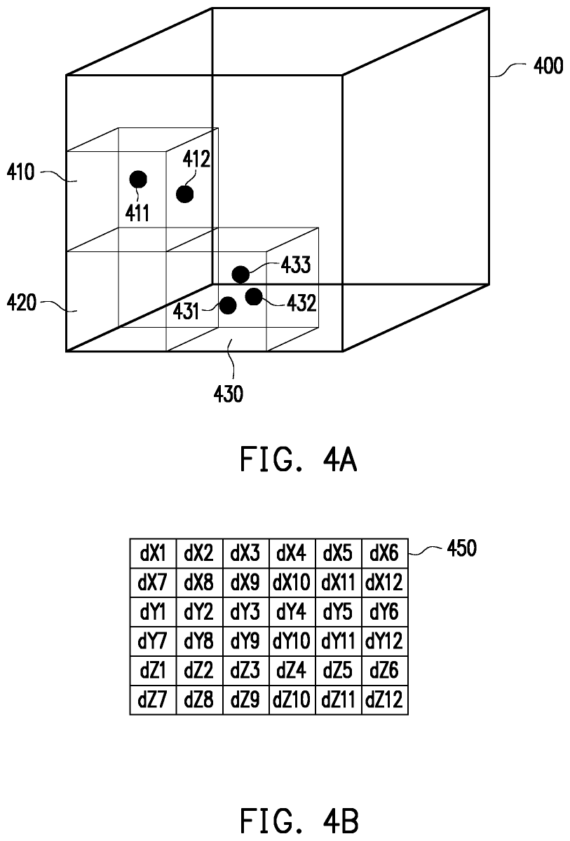

FIG. 5 is a schematic diagram showing generating the value associated with the residual point cloud according to the embodiment of the disclosure. The computing module 121 may determine the number M of residual points in the reference residual point cloud according to the predicting model 123. Herein, the predicting model 123 may be an adaptive predictor. After determine the number M of residual points in the reference residual point cloud, the computing module 121 may subtract the number N of residual points in the current residual point cloud in the sub-bounding box from the number M of residual points in the reference residual point cloud to generate the value associated with the residual point cloud, as shown in formula (2), where Delta represents the value associated with the residual point cloud.

Delta=N−M (2)

Taking the sub-bounding box 410 of FIG. 4A as an example, it is assumed that in the previous frame, the residual point cloud in the sub-bounding box 410 is formed of the residual point 411, and in the current frame, the residual point cloud in the sub-bounding box 410 is formed of the residual points 411 and 412. Where the residual point 411 in the previous frame is known to the decoding end (e.g., the electronic device 200), the encoding end (e.g., the electronic device 100) only requires to transmit information related to the residual point 412 to the decoding end for the decoding end to completely restore the residual point cloud in the sub-bounding box 410. Therefore, the computing module 121 may subtract the number 1 of the residual point (i.e., the residual point 411) corresponding to the previous frame from the number 2 of the residual points (i.e., the residual points 411 and 412) corresponding to the current frame to calculate that the value associated with the residual point cloud is 2−1=1.

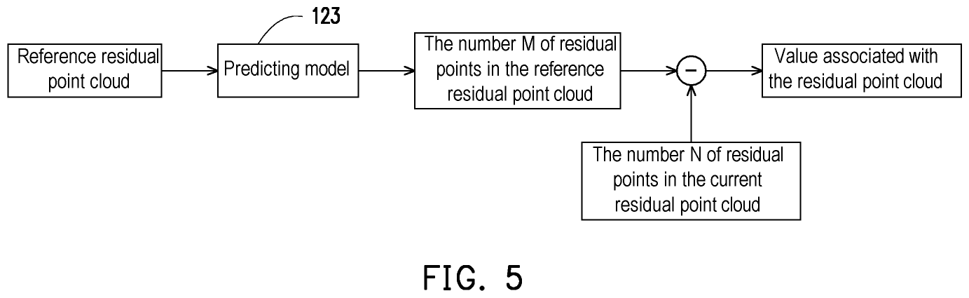

In step S315, the computing module 121 may calculate a vector between the reference point in the sub-bounding box and each residual point in the residual point cloud in the sub-bounding box. Taking FIG. 6A, FIG. 6B, and FIG. 6C as an example, FIG. 6A, FIG. 6B, and FIG. 6C are schematic diagrams showing a sub-bounding box and a raw patch according to an embodiment of the disclosure. It is assumed that a sub-bounding box 610 in a bounding box 600 may include a residual point cloud formed of a residual point 612 at a coordinate (3, 258, 1), a residual point 613 at a coordinate (6, 260, 1), and a residual point 614 at a coordinate (1, 262, 9). The computing module 121 may define a point at a coordinate (0, 256, 0) in the sub-bounding box 610 as the reference point. The computing module 121 may calculate that a vector between the residual point 612 and a reference point 611 is (3, 2, 1), a vector between the residual point 613 and the reference point 611 is (6, 4, 1), and a vector between the residual point 614 and the reference point 611 is (1, 6, 9).

In step S317, the computing module 121 may generate the raw patch according to a side length of the raw patch and the vector between the reference point and the residual point. Specifically, the computing module 121 may fill the vector between each residual point and the reference point into 3 data points in a column or a row of the raw patch. For example, the computing module 121 may sequentially fill the vector between the residual point 612 and the reference point 611 as (3, 2, 1), the vector between the residual point 613 and the reference point 611 as (6, 4, 1), and the vector between the residual point 614 and the reference point 611 as (1, 6, 9) into a column of a raw patch 650, as shown in FIG. 6B. For another example, the computing module 121 may sequentially fill the vector between the residual point 612 and the reference point 611 as (3, 2, 1), the vector between the residual point 613 and the reference point 611 as (6, 4, 1), and the vector between the residual point 614 and the reference point 611 as (1, 6, 9) into a row of a raw patch 660, as shown in FIG. 6C.

After generating the raw patch of the sub-bounding box, in step S319, the computing module 121 may delete the residual point cloud in the sub-bounding box, and execute step S309 again to confirm whether a sub-bounding box that includes a residual point cloud is still present in the bounding box and has not been converted into a raw patch.

In step S321, the image encoding module 122 may generate image data. The image data may include the patch generated from the surrounding point cloud, and may include the raw patch generated from the residual point cloud in each sub-bounding box. The image encoding module 122 may encode the image data according to an image encoding algorithm, for example but not limited to an HEVC algorithm, an H.264 algorithm, an H.266 algorithm, an H.267 algorithm, an H.268 algorithm, an H.269 algorithm, or the like, to generate encoded image data. After the encoded image data is generated, the computing module 121 may output the encoded image data and the syntax through the transceiver 130 to the decoding end (e.g., the electronic device 200).

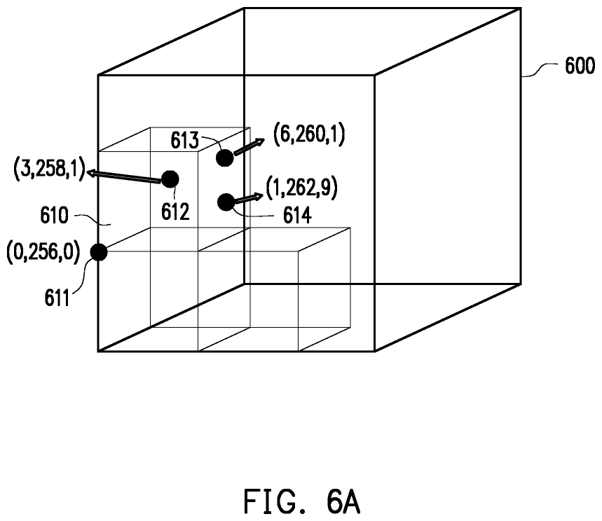

FIG. 7 is a schematic diagram showing the electronic device 200 for decoding a point cloud according to the embodiment of the disclosure. The electronic device 200 may include a processor 210, a storage medium 220, and a transceiver 230.

The processor 210 is, for example, a central processing unit (CPU), or any other programmable general-purpose or special-purpose micro control unit (MCU), microprocessor, digital signal processor (DSP), programmable controller, application-specific integrated circuit (ASIC), graphic processing unit (GPU), image signal processor (ISP), image processing unit (IPU), arithmetic logic unit (ALU), complex programmable logic device (CPLD), field programmable gate array (FPGA), or other similar elements or a combination of the above elements. The processor 210 may be coupled to the storage medium 220 and the transceiver 230, and access and execute a plurality of modules and various applications stored in the storage medium 220.

The storage medium 220, for example, is a fixed or portable element in any form such as random access memory (RAM), read only memory (ROM), flash memory, hard disk drive (HDD), solid state drive (SSD), or a combination of the above elements, and is configured to store a plurality of modules or various application programs that may be executed by the processor 210. In this embodiment, the storage medium 220 may store a plurality of modules including a computing module 221, an image decoding module 222, and a predicting model 223, and functions thereof will be described later.

The transceiver 230 transmits and receives signals in a wireless or wired manner. The transceiver 230 may also perform operations such as low noise amplification, impedance matching, frequency mixing, frequency up-conversion or down-conversion, filtering, amplification, and the like.

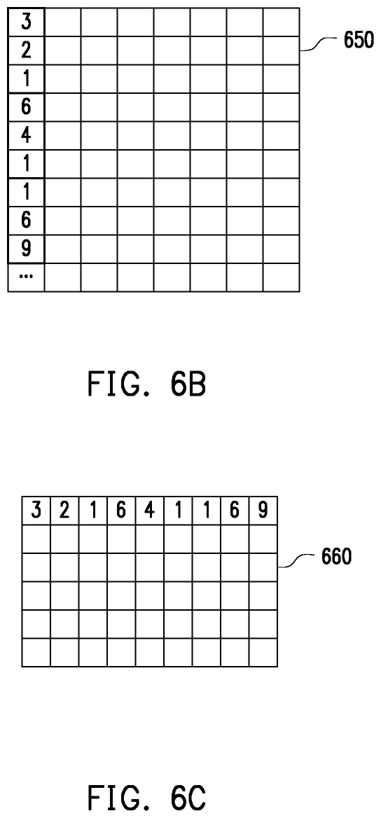

FIG. 8 is a flow chart showing a method for decoding a point cloud according to an embodiment of the disclosure. Herein, the method may be implemented by the electronic device 200 as shown in FIG. 7.

In step S801, the computing module 221 may receive encoded image data and syntax from the electronic device 100 through the transceiver 230.

In step S803, the image decoding module 222 may decode the encoded image data to obtain image data. The image decoding module 222 may decode the encoded image data according to an image decoding algorithm, for example but not limited to an HEVC algorithm, an H.264 algorithm, an H.266 algorithm, an H.267 algorithm, an H.268 algorithm, an H.269 algorithm, or the like, to generate the image data. The image data may include a patch corresponding to a surrounding point cloud and a raw patch corresponding to a residual point cloud. Herein, a side length of the raw patch may be associated with the image decoding algorithm used by the image decoding module 222. The image decoding module 222 may obtain the patch and the raw patch from the image data.

In step S805, the computing module 221 may obtain a vector between a reference point in a sub-bounding box and each residual point in the residual point cloud in the sub-bounding box from the raw patch.

In step S807, the computing module 221 may reconstruct the point cloud according to the patch, the raw patch, and the syntax. Specifically, the computing module 221 may reconstruct the surrounding point cloud of the point cloud (or a current surrounding point cloud corresponding to a current frame) according to the patch, and may reconstruct the residual point cloud of the point cloud (or a current residual point cloud corresponding to the current frame) according to the vector obtained from the raw patch and the syntax, thus achieving reconstruction of the point cloud. Herein, the syntax may include a coordinate of the reference point in each sub-bounding box and a value associated with the residual point cloud.

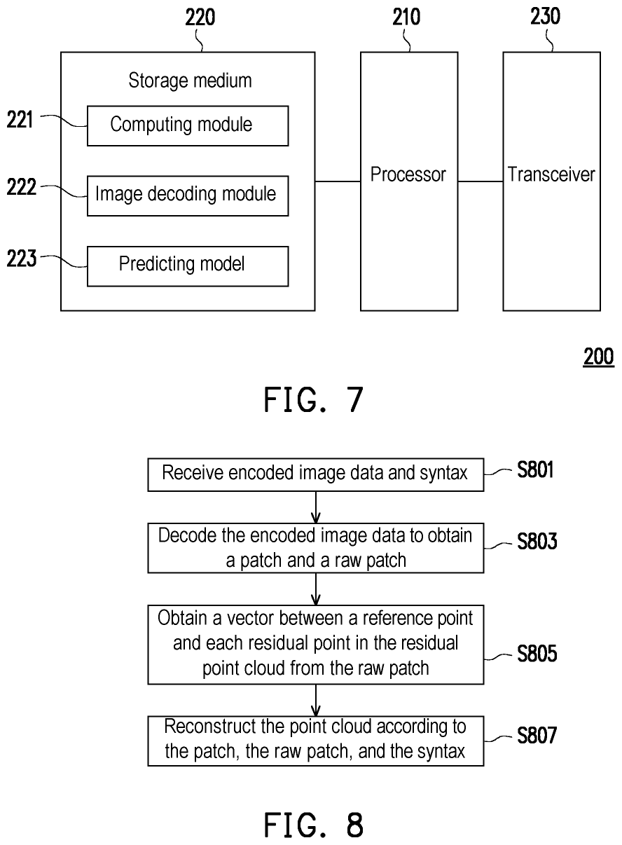

FIG. 9 is a schematic diagram showing calculating the number of residual points in the current residual point cloud according the embodiment of the disclosure. The computing module 221 may determine the number M of residual points in the reference residual point cloud according to the predicting model 223. Herein, the predicting model 223 may be an adaptive predictor. On the other hand, the computing module 221 may obtain the value associated with the residual point cloud from the syntax. The computing module 221 adds the number M of residual points in the reference residual point cloud and the value associated with the residual point cloud to generate the number N of residual points in the current residual point cloud, as shown in formula (3), where Delta represents the value associated with the residual point cloud. After obtaining the number N of residual points in the current residual point cloud, the computing module 221 may reconstruct the current residual point cloud according to the vector obtained from the raw patch, the coordinate of the reference point in the syntax, and the number N of residual points in the current residual point cloud.

N=M+Delta (3)

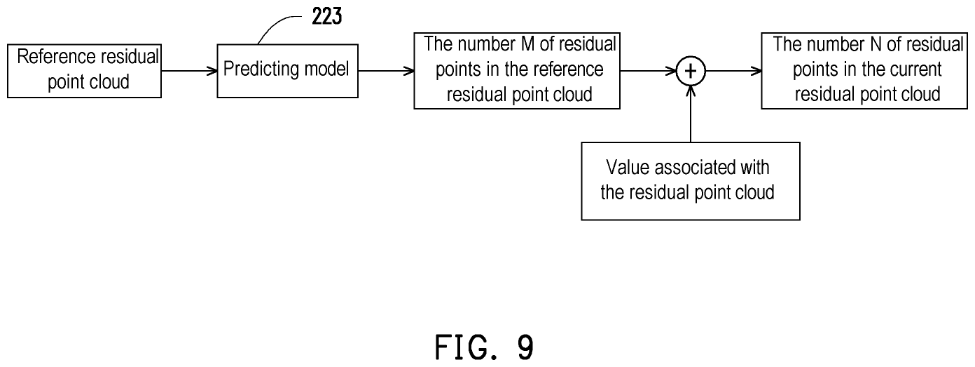

FIG. 10 is a flow chart showing a method for encoding a point cloud according to another embodiment of the disclosure. Herein, the method may be implemented by the electronic device 100 as shown in FIG. 2. In step S1001, a point cloud is obtained. Herein, the point cloud includes a plurality of points in a bounding box. In step S1003, a residual point cloud is obtained from the point cloud. In step S1005, a reference point in the bounding box is defined. In step S1007, a raw patch is generated according to the reference point and the residual point cloud. In step S1009, image data is generated according to the raw patch, and encoded image data is generated according to the image data. In step S1011, the encoded image data is output.

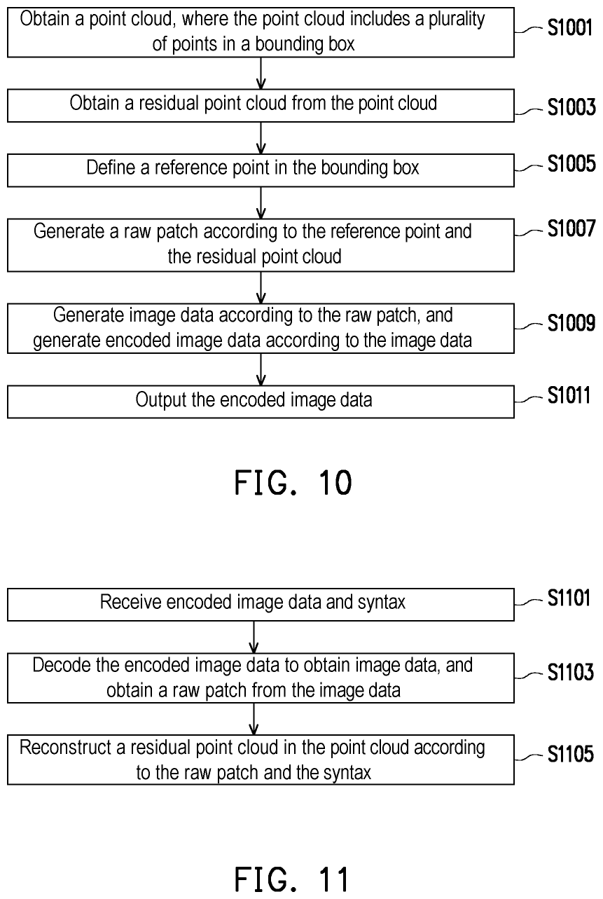

FIG. 11 is a flow chart showing a method for decoding a point cloud according to another embodiment of the disclosure. Herein, the method may be implemented by the electronic device 200 as shown in FIG. 7. In step S1101, encoded image data and syntax are received. In step S1103, the encoded image data is decoded to obtain image data, and a raw patch is obtained from the image data. In step S1105, a residual point cloud in the point cloud is reconstructed according to the raw patch and the syntax.

In summary of the foregoing, in the disclosure, the information of the residual point cloud may be retrieved with the raw patch. The raw patch generated from the residual point cloud and the other patches generated from the surrounding point cloud may be included in the same image data. Therefore, the raw patch does not occupy excessive data space. Accordingly, the point cloud restored in the decoding method according to the disclosure will not lose the information related to the residual point cloud, thus not resulting in distortion. In the disclosure, the previous frame of the point cloud video may also serve as the reference point cloud. When the point cloud corresponding to the current frame of the point cloud video is encoded to generate the encoded data, it is possible that the point information repeatedly included in the residual point cloud of the point cloud and the residual point cloud of the reference point cloud is not encoded into the encoded data, thereby increasing the compression ratio of the point cloud.

1. An electronic device for encoding a point cloud, comprising:
a transceiver, obtaining the point cloud, wherein the point cloud comprises a plurality of points in a bounding box;
a storage medium, storing a plurality of modules; and
a processor, coupled to the storage medium and the transceiver, and accessing and executing the plurality of modules, wherein the plurality of modules comprise:
a computing module, obtaining a residual point cloud from the point cloud, defining a reference point in the bounding box, and generating a raw patch according to the reference point and the residual point cloud; and
an image encoding module, generating image data according to the raw patch, and generating encoded image data according to the image data, wherein
the computing module outputs the encoded image data through the transceiver.

2. The electronic device as described in claim 1, wherein the computing module generates syntax according to the reference point and the residual point cloud, and outputs the syntax through the transceiver, wherein the syntax comprises a coordinate of the reference point and a value associated with the residual point cloud.

3. The electronic device as described in claim 2, wherein a current residual point cloud corresponds to a current frame of a point cloud video and comprises N points, wherein a reference residual point cloud corresponds to a previous frame of the point cloud video and comprises M points, wherein the computing module calculates a difference between the N points and the M points to generate the value, and wherein N and M are positive integers.

4. The electronic device as described in claim 3, wherein M is equal to 1.

5. The electronic device as described in claim 3, wherein the plurality of modules further comprise:
a predicting model, determining the M points according to the reference residual point cloud.

6. The electronic device as described in claim 1, wherein the computing module calculates a vector between the reference point and each point in the residual point cloud to generate the raw patch.

7. The electronic device as described in claim 1, wherein the bounding box comprises one or more sub-bounding boxes, wherein the residual point cloud comprises a first residual point cloud corresponding to a sub-bounding box in the one or more sub-bounding boxes, wherein the computing module generates the raw patch according to the first residual point cloud and the reference point corresponding to the sub-bounding box.

8. The electronic device as described in claim 1, wherein the computing module determines a patch size of the raw patch according to an image encoding algorithm used by the image encoding module.

9. The electronic device as described in claim 1, wherein the computing module projects a surrounding point cloud in the point cloud onto the bounding box to generate a plurality of patches, and removes the surrounding point cloud from the point cloud to generate the residual point cloud, wherein the image encoding module generates the image data comprising the plurality of patches and the raw patch.

10. The electronic device as described in claim 1, wherein the image encoding module generates the encoded image data according to one of image encoding algorithms below: an HEVC algorithm, an H.264 algorithm, an H.266 algorithm, an H.267 algorithm, an H.268 algorithm, and an H.269 algorithm.

11. An electronic device for decoding a point cloud, comprising:
a transceiver, receiving encoded image data and syntax;
a storage medium, storing a plurality of modules; and
a processor, coupled to the storage medium and the transceiver, and accessing and executing the plurality of modules, wherein the plurality of modules comprises:
an image decoding module, decoding the encoded image data to obtain image data, and obtaining a raw patch from the image data; and
a computing module, reconstructing a residual point cloud in the point cloud according to the raw patch and the syntax.

12. The electronic device as described in claim 11, wherein the syntax comprises a coordinate of a reference point in a bounding box of the point cloud and a value associated with the residual point cloud.

13. The electronic device as described in claim 12, wherein a current residual point cloud corresponds to a current frame of a point cloud video and comprises N points, wherein a reference residual point cloud corresponds to a previous frame of the point cloud video and comprises M points, wherein the value is a difference between the N points and the M points, and wherein N and M are positive integers.

14. The electronic device as described in claim 13, wherein M is equal to 1.

15. The electronic device as described in claim 13, wherein the plurality of modules further comprise:
a predicting model, determining the M points according to the reference residual point cloud.

16. The electronic device as described in claim 12, wherein the raw patch comprises a vector between the reference point and each point in the residual point cloud.

17. The electronic device as described in claim 12, wherein the bounding box comprises one or more sub-bounding boxes, wherein the residual point cloud comprises a first residual point cloud corresponding to a sub-bounding box in the one or more sub-bounding boxes, wherein the computing module reconstructs the residual point cloud according to the raw patch and the syntax.

18. The electronic device as described in claim 11, wherein a patch size of the raw patch is associated with an image decoding algorithm used by the image decoding module.

19. The electronic device as described in claim 2, wherein the image data comprises a plurality of patches and the raw patch, wherein the computing module reconstructs a surrounding point cloud according to the plurality of patches, and reconstructs the point cloud according to the surrounding point cloud and the residual point cloud, wherein the plurality of patches respectively correspond to a plurality of projections of the surrounding point cloud on the bounding box.

20. The electronic device as described in claim 11, wherein the image decoding module decodes the encoded image data according to one of image encoding algorithms below: an HEVC algorithm, an H.264 algorithm, an H.266 algorithm, an H.267 algorithm, an H.268 algorithm, and an H.269 algorithm.

21. A method for encoding a point cloud, comprising:
obtaining the point cloud, wherein the point cloud comprises a plurality of points in a bounding box;
obtaining a residual point cloud from the point cloud;
defining a reference point in the bounding box;
generating a raw patch according to the reference point and the residual point cloud;
generating image data according to the raw patch, and generating encoded image data according to the image data; and
outputting the encoded image data.

22. A method for decoding a point cloud, comprising:
receiving encoded image data and syntax;
decoding the encoded image data to obtain image data, and obtaining a raw patch from the image data; and
reconstructing a residual point cloud in the point cloud according to the raw patch and the syntax.
